(19) United States
(12) Patent Application Publication
(10) Pub. No.: US 2024/0287321 A1
(43) Pub. Date: Aug. 29, 2024

(54) ANTIBACTERIAL COATING COMPOSITION, AND METHOD FOR MANUFACTURING OPTICAL FILM INCLUDING ANTIBACTERIAL NANOPARTICLES

(71) Applicant: SHARECHEM, Daejeon (KR)

(72) Inventors: Yongjoo KIM, Hwaseong-si (KR); Jaeho CHOI, Suwon-si (KR); Sehoon HAN, Hwaseong-si (KR); Young Sam JIN, Gwangju-si (KR); Byongwook LEE, Hwaseong-si (KR); Myeongjin OH, Suwon-si (KR)

(21) Appl. No.: 18/573,018

(22) PCT Filed: Sep. 2, 2021
(86) PCT No.: PCT/KR2021/095080

§ 371 Date: Dec. 21, 2023

(30) Foreign Application Priority Data
Jun. 24, 2021 (KR) 10-2021-0081987

(51) Int. Cl. C09D 5/14; A01N 59/20; A01P 1/00; C08K 3/30; C08K 3/36; C08K 9/02; C08K 9/04; C09D 7/62; C09D 133/08; G02B 1/18

(52) U.S. Cl. CPC C09D 5/14; A01N 59/20; A01P 1/00; C09D 7/62; C09D 133/08; C08K 2003/3009; C08K 3/36; C08K 9/02; C08K 9/04; C08K 2201/003; G02B 1/18

(57) ABSTRACT

The present invention relates to antibacterial nanoparticles, a hard coating composition comprising same, a hard coating, and an antibacterial optical film, and specifically, to antibacterial particles, a hard coating composition comprising same, a hard coating, and an antibacterial optical film, wherein the antibacterial particles include silica particles and Cu—S-based nanoparticles bonded to the surface of the silica particles.

### BACKGROUND OF THE INVENTION

### 1. Field of the Invention

The present invention relates to antibacterial nanoparticles, a hard coating composition comprising same, a hard coating, and an antibacterial optical film.

### 2. Description of the Related Art

Thin display devices using flat panel displays such as liquid crystal displays (LCDs) or organic light emitting displays (LED displays) are implemented in the form of touch screen panels, and are widely used in a variety of smart devices that feature portability, from smartphones and tablet PCs to various wearable devices.

These portable touchscreen panel-based display devices are equipped with a display protective window film on the display panel to protect the display panel from scratches or external impacts, and in most cases, tempered glass is used as the window film. Tempered glass for displays is thinner than regular glass, but is characterized by high strength and resistance to scratches.

However, tempered glass has the disadvantage of being heavy, which makes it unsuitable for lightweighting portable devices; it is vulnerable to external impacts, making it difficult to achieve shatterproof properties; and it does not bend beyond a certain level, making it unsuitable as a flexible display material that can be bent or folded.

Meanwhile, various studies are being conducted on optical plastic covers that secure flexibility and impact resistance while also having strength or scratch resistance equivalent to tempered glass. In general, transparent plastic cover materials for optics that are more flexible include polyethylene terephthalate than tempered glass (PET), polyethersulfone (PES), polyethylene naphthalate (PEN), polyacrylate (PAR), polycarbonate (PC), and polyimide (PI), etc. However, these polymer plastic substrates have the disadvantage of not being as hard and scratch-resistant as tempered glass, which is used as a window film for display protection, and also not having sufficient impact resistance. Accordingly, various attempts are being made to supplement the required physical properties by coating these plastic substrates with a composite resin composition.

In this regard, hard coating is formed on a plastic base film to secure high hardness, and a composition consisting of a curable resin, a curing agent or a curing catalyst, and other additives has been generally used. To strengthen its optical properties and hardness, Korean Patent Publication No. 10-2009-0080644, Korean Patent No. 10-0818631, and Korean Patent Publication No. 10-2009-0044089 disclose a method for preparing a hard coating solution using urethane acrylate oligomer, silica, silane-based compounds, especially siloxane compounds, titanium alkoxide, titanium oxide, tin oxide, zirconium oxide, and the like.

However, the hard coating formed with this hard coating solution has the disadvantage of having lower antibacterial properties compared to tempered glass.

Meanwhile, substances used to have antibacterial properties include nano silver, zinc oxide, and antibacterial copper. However, when these materials are included in the hard coating solution to form a thin film, it is difficult to form a uniform thin film because they are not uniformly dispersed in the hard coating solution, and even if a thin film is formed, the optical properties such as transparency are reduced, making it difficult to use as an optical film.

Accordingly, the present inventors completed the present invention by developing antibacterial particles comprising silica particles and Cu—S-based nanoparticles bonded to the surface e of the silica particles as the antibacterial particles having excellent optical properties and at the same time having remarkably good antibacterial and wear resistance properties, and a hard coating composition comprising the same in order to solve the above-mentioned problems.

### SUMMARY OF THE INVENTION

In one aspect, an object of the present invention is to provide antibacterial nanoparticles, a hard coating composition comprising the same, a hard coating, and an antibacterial optical film.

To achieve the above object, in one aspect, the present invention provides antibacterial particles comprising silica particles and Cu—S-based nanoparticles bonded to the surface of the silica particles.

At this time, the average diameter of the silica particles may be 0.1 μm to 20 μm.

In addition, the average diameter of the Cu—S-based nanoparticles is 10 nm to 100 nm.

Further, the Cu—S-based nanoparticles are copper sulfide nanoparticles having an atomic ratio of Cu:S of 1:0.5 to 1:15.

In addition, the Cu—S-based nanoparticles are surface modified to introduce organic functional groups on the surface.

In another aspect, the present invention provides a hard coating composition, comprising a photo-curable resin and the antibacterial particles.

The photo-curable resin may be an acrylate-based resin.

The hard coating composition may further include a photoinitiator.

The hard coating composition may include the photo-curable resin and antibacterial particles in a weight ratio of 30:1 to 30:2.

In another aspect, the present invention provides a resin and hard coating comprising a photo-curable antibacterial particles.

In another aspect, the present invention provides an antibacterial optical film comprising an optical substrate and the hard coating.

The hard coating may have a thickness of 5 μm to 50 μm.

In another aspect, the present invention provides a method for producing antibacterial particles, comprising a step of binding Cu—S-based nanoparticles to the surface of silica particles.

At this time, the method for producing antibacterial particles further includes a step of surface modifying the Cu—S-based nanoparticles to introduce organic functional groups on the surface.

### Advantageous Effect

The antibacterial particles according to one aspect of the present invention have the advantages of excellent light transmittance, antibacterial properties, and wear resistance.

Accordingly, the hard coating comprising the antibacterial particles and the antibacterial optical film comprising the same have the advantages of high light transmittance and significantly excellent antibacterial properties and wear resistance.

Therefore, the hard coating composition and the hard coating comprising the antibacterial particles can be usefully applied to touch displays such as smartphones, tablets, keyhosks, and the surfaces of various household goods.

The effects of the present invention are not limited to those mentioned above, and other effects not mentioned will be clearly understood by those skilled in the art from the description below.

### BRIEF DESCRIPTION OF THE DRAWINGS

FIG. 1 is a schematic diagram showing the antibacterial particles according to one aspect of the present invention.

FIG. 2 is a schematic diagram showing the hard coating according to one aspect of the present invention and the antibacterial optical film comprising the same.

FIG. 3 is a photograph of the surface of an antibacterial optical film comprising the antibacterial particles according to one aspect of the present invention observed using a scanning electron microscope (SEM).

FIG. 4 shows the results of analyzing the surface of an antibacterial optical film comprising the antibacterial particles according to one aspect of the present invention using energy dispersive X-ray spectroscopy (EDS).

FIG. 5 is a photograph of the surface of an antibacterial optical film manufactured according to a comparative example observed before and after abrasion resistance evaluation using an optical microscope (OM).

FIG. 6 is a photograph of the surface of an antibacterial optical film manufactured according to an example observed before and after abrasion resistance evaluation using an optical microscope (OM).

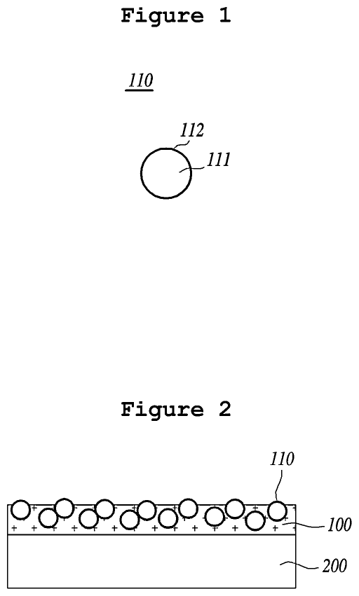

### DESCRIPTION OF THE PREFERRED EMBODIMENTS

Hereinafter, the present invention is described in detail.

The composition of the present invention comprises antibacterial particles, and preferably contains the photo-curable resin and the antibacterial particles in a weight ratio of 30:1 to 30:2.

It is intended that the hard coating formed with the composition for hard coating has an excellent wear resistance and at the same time has a significantly excellent light transmittance of at least 90%, preferably 90% to 99%, and a significantly good antibacterial property of at least 90.0%, preferably at least 99.0%, more preferably 99.0% to 99.9%.

If the content of the antibacterial particles is less than the above range, a problem may occur in which the antibacterial property of the hard coating formed with the hard coating composition is lowered to less than 90.0%. And, if the content of the antibacterial particles is higher than the above range, the light transmittance of the hard coating formed with the hard coating composition may be significantly reduced, making it difficult to use as an optical film.

At this time, the photo-curable resin is preferably an acrylate-based resin.

For example, the photo-curable resin can include one or more of dipentaerythritol hexa(meth)acrylate, dipentaerythritol penta(meth)acrylate, pentaerythritol tetra(meth)acrylate, ditrimethylolpropane tetra(meth)acrylate, (meth)acrylate containing an oxyethylene group, ester (meth)acrylate, ether (meth)acrylate, urethane (meth)acrylate, epoxy (meth)acrylate, and melamine (meth)acrylate.

In addition, the photo-curable resin may comprise an organic compound containing at least one, preferably at least three methacrylate functional groups. And, the photo-curable resin may comprise an organic compound containing at least four, preferably at least nine urethane acrylate functional groups. More preferably, the photo-curable resin may comprise an organic compound containing at least three methacrylate functional groups and an organic compound containing at least nine urethane acrylate functional groups.

The hard coating composition may include the photo-curable resin by 20 to 50 weight % based on the total weight of the hard coating composition.

For example, the hard coating composition may comprise 5 to 15 weight % of the organic compound containing at least three methacrylate functional groups, and 10 to 30 weight % of the organic compound containing at least nine urethane acrylate functional groups, as the photo-curable resin.

In addition, the hard coating composition may further include a photoinitiator.

At this time, the photoinitiator is not particularly limited as long as it can form radicals by light irradiation.

For example, the photoinitiator may be one or more of acetophenones such as 1-hydroxycyclohexylphenylketone, 4-phenoxydichloroacetphenone, 4-t-butyldichloroacetphenone, 4-t-butyltrichloroacetphenone, diethoxyacetphenone, 2-hydroxy-2-methyl-1-phenylpropane-1-one, 1-(4-isopropylphenyl)-2-hydroxy-2-methylpropane-1-one, 1-(4-dodecylphenyl)-2-hydroxy-2-methylpropan-1-one and 4-(2-hydroxyethoxy)-phenyl(2-hydroxy-2-propyl) ketone, benzoins such as benzoin, benzoin methyl ether, benzoin ethyl ether and benzyl dimethyl ketal, acylphosphine oxides, and titanocene compounds.

The hard coating composition may include the curing initiator by 0.1 to 10 weight %, preferably 0.5 to 5 weight % based on the total weight of the hard coating composition.

If the hard coating composition contains less than 0.1 weight % of the curing initiator, the mechanical properties and adhesion of the manufactured hard coating may be reduced due to insufficient curing, and if it contains more than 10 weight %, cracking may occur due to curing shrinkage.

In addition, the hard coating composition may further include a solvent.

At this time, the solvent is not particularly limited as long as it can dissolve or disperse the antibacterial particles, the photo-curable resin, and the photoinitiator.

Examples of the solvent include alcohols (methanol, ethanol, isopropanol, butanol, propylene glycol methoxy alcohol, etc.), ketones (methyl ethyl ketone, methyl butyl ketone, methyl isobutyl ketone, diethyl ketone, dipropyl ketone, etc.), acetates (methyl acetate, ethyl acetate, butyl acetate, propylene glycol methoxy acetate, etc.), cellosolves (methyl cellosolve, ethyl cellosolve, propyl cellosolve, etc.), and hydrocarbons (normal hexane, normal heptane, benzene, toluene, xylene, etc.), which can be used alone or in a mixture of two or more.

The content of the solvent may be 5 to 90 weight % based on the total weight of the hard coating composition, but not always limited thereto.

The hard coating composition according to another aspect of the present invention may further include at least one of a leveling agent, an UV stabilizer, and a heat stabilizer as additives.

The leveling agent is added to improve the smoothness and applicability when applying the hard coating composition on a substrate, and a silicone leveling agent, a fluorine leveling agent, an acrylic leveling agent, and the like can be used.

The UV stabilizer is added to prevent the surface of the hard coating formed with the hard coating composition from being discolored or brittle by continuous exposure to ultraviolet rays, and plays a role in blocking or absorbing ultraviolet rays.

The UV stabilizer may be, for example, phenyl salicylate (absorbent), benzophenone (absorbent), benzotriazole (absorbent), nickel derivative (quencher), radical scavenger, etc.

Polyphenol-based, phosphite-based, and lactone-based stabilizers can be used as the heat stabilizer. The UV stabilizer and heat stabilizer can be used by mixing them in an appropriate amount at a level that does not affect UV curability.

The additives may be contained in an amount of 0.1 to 3% of the total weight of the hard coating composition, but not always limited thereto.

In another aspect, the present invention provides a hard coating comprising a photo-curable resin and antibacterial particles.

The hard coating may comprise some or all of the components of the hard coating composition described above. The hard coating may be formed in various thicknesses as required, but when formed on an optical substrate, it may preferably have a thickness of 5 μm to 50 μm, and more preferably 10 μm to 30 μm.

In another aspect, the present invention provides an antibacterial optical film comprising an optical substrate and the hard coating.

FIG. 2 is a schematic diagram showing the antibacterial optical film according to another aspect of the present invention.

As shown in FIG. 2, the antibacterial optical film according to another aspect of the present invention is one in which the antibacterial hard coating (100) is formed on at least one surface of the substrate (200). The antibacterial optical film has excellent antibacterial properties, light transmittance, surface hardness, scratch resistance, chemical and thermal stability, and anti-fouling properties, so it can be usefully applied to touch displays such as smartphones, tablets, keyhosks, and the surfaces of various household goods.

At this time, as the optical substrate (200), various substrates used for optical films can be used, and is not particularly limited.

The optical substrate (200) is, for example, a transparent polymer film, which may be a film formed of polymers such as triacetyl cellulose, acetyl cellulose butyrate, ethylene-vinyl acetate copolymer, propionyl cellulose, butyryl cellulose, acetyl propionyl cellulose, polyester, polystyrene, polyamide, polyetherimide, polyacryl, polyimide, polyethersulfone, polysulfone, polyethylene, polypropylene, polymethylpentene, polyvinyl chloride, polyvinylidene chloride, polyvinyl alcohol, polyvinyl acetal, polyether ketone, polyether ether ketone, polyether sulfone, polymethyl methacrylate, polyethylene terephthalate, polybutylene terephthalate, polyethylene naphthalate and polycarbonate, and these polymers can be used alone or in a mixture of two or more.

In order to exhibit excellent hardness and flexibility, the hard coating (100) may preferably have a thickness of 5 μm to 50 μm, more preferably 10 μm to 30 μm.

The antibacterial optical film can be provided as an outermost window film in various image display devices, including conventional liquid crystal display devices, electroluminescent display devices, plasma display devices, field emission display devices, and the like.

In another aspect, the present invention provides a method for producing antibacterial particles, comprising a step of binding Cu—S-based nanoparticles to the surface of silica particles.

Hereinafter, the method for producing antibacterial nanoparticles according to another aspect of the present invention will be described in detail in each step.

First, the method for producing antibacterial nanoparticles according to another aspect of the present invention may further include a step of producing Cu—S-based nanoparticles.

The Cu—S-based nanoparticles can be prepared by adding a precipitant to a solution containing a copper ion salt and a sulfide salt.

For example, Cu—S nanoparticles can be prepared by mixing and heating a solution of copper acetate monohydrate and sodium lauryl sulfate dissolved in an ultrapure solvent (solution A) and a solution of thiourea dissolved in an ultrapure solvent (solution B).

In addition, the method for producing antibacterial nanoparticles according to another aspect of the present invention may further include a step of surface modifying the Cu—S-based nanoparticles to introduce organic functional groups on the surface.

This step can be performed by combining a multifunctional organic compound containing the organic functional group with the Cu—S-based nanoparticles.

At this time, the organic functional group is not limited as long as it is a functional group capable of organic bonding with OH on the surface of silica, such as carboxyl groups, ester groups, anhydride groups, (meth)acrylic groups, etc.

In addition, the multifunctional organic compound may be an organic compound containing two or more functional groups selected from the group consisting of carboxyl groups, ester groups, and acrylic groups. For example, the multifunctional organic compound may include succinic acid, maleic acid, propionic acid, malonic acid, malic acid, glutaric acid, and the like.

The method for producing antibacterial nanoparticles according to another aspect of the present invention may include a step of bonding the Cu—S-based nanoparticles to the surface of the silica particles after surface modification of the Cu—S-based nanoparticles.

At this time, the silica particles and the Cu—S-based nanoparticles may be mixed at a weight ratio of 1:1 to 1:10.

In another aspect, the present invention provides a method for producing an antibacterial optical film, comprising a step of forming the hard coating on an optical substrate.

At this time, the step of forming the hard coating on an optical substrate may include a step of applying the hard coating composition to the substrate; and a step of drying and curing the hard coating composition.

The application may be accomplished by any of the following known methods: slit coating, knife coating, spin coating, casting, micro-gravure coating, gravure coating, bar coating, roll coating, wire bar coating, dip coating, spray coating, printing, gravure screen printing, flexographic printing, offset printing, inkjet coating, dispenser printing, nozzle coating, capillary coating, and the like.

Hereinafter, the present invention will be described in detail by the following examples and experimental examples.

However, the following examples and experimental examples are only for illustrating the present invention, and the contents of the present invention are not limited thereto.

### Example 1

Step Copper (II) acetate monohydrate (27 g) and sodium lauryl sulfate (9 g) were added to ultrapure water (0.9 L), a solvent, which was stirred for 1 hour while heating at 70° C. (solution A). Thiourea (20.5 g) was added to ultrapure water (0.75 L), which was stirred for 1 hour while heating at 70° C. (solution B). Then, solution B was mixed with solution A and stirred at 60° C. for 24 hours to prepare Cu—S nanoparticles with a size of 10 nm. Afterwards, the solution containing the Cu—S nanoparticles was centrifuged at 8000 rpm for 30 minutes to remove the upper solution, and washed several times with ultrapure water and ethanol solvent to obtain solid Cu—S nanoparticles.

Step 2: 10 g of the Cu—S nanoparticles obtained in step 1 above were added to 1 L of ethanol and stirred at 500 rpm for 1 hour at 60 degrees, to which 20 g of maleic acid was added and stirred for 6 hours. The mixed solution was then centrifuged at 8000 rpm for 30 minutes to remove the upper solution, and washed several times with methyl ethyl ketone (MEK) solvent to obtain surface-modified solid Cu—S nanoparticles.

Step 3: The surface-modified Cu—S nanoparticles were prepared at a solid content of 25 wt % in methyl ethyl ketone (MEK) solvent, and physically dispersed using a basket mill (bead: 2 mm, 2000 rpm, 2 hr) to prepare a uniformly dispersed Cu—S nanoparticle dispersion.

Step 4: To 100 g of the Cu—S nanoparticle dispersion with a solid content of 25 wt %, 25 g of 10 μm-sized silica particles were added and stirred at 8000 rpm for 30 minutes in a high-speed homogenizer to homogenize the silica particles and Cu—S nanoparticles, and then subjected to a heterojunction step at 60 degree for 3 hours at 300 rpm to prepare a dispersion comprising the antibacterial particles including silica particles and Cu—S-based nanoparticles bonded to the surface of the silica particles.

Step 5: A hard coating composition was prepared by mixing 10 wt % of a monomer containing three methacrylates (M301, Miwon Commercial Co., Ltd.), 20 wt % of a monomer containing nine urethane acrylates (SC2100, Miwon Commercial Co., Ltd.), 1 wt % of 1-hydroxycyclohexylphenylketone (Igacure-184, Ciba) as a photoinitiator, 3 wt % of 2,4,6-trimethylbenzoyl-diphenyl-diphenylphosphine (TPO, Miwon Commercial Co., Ltd.), 30 wt % of methyl ethyl ketone (Daejung Chemicals & Metals Co., Ltd.) and 30 wt % of toluene (Daejung Chemicals & Metals Co., Ltd.) as a solvent, and adding 6 wt % of a dispersion containing the antibacterial particles (contains 1.5 wt % of antibacterial nanoparticles).

Step 6: The hard coating composition was applied to a PET substrate at a speed of 1 m/min using a bar coater and dried in a dry oven at 120° C. for 1 minute. An optical film with a 20 μm-thick hard coating was prepared by irradiating ultraviolet rays of 400 mJ/cm² to the dried substrate.

### Example 2

An optical film was prepared in the same manner as in Example 1, except that 3 wt % of the dispersion containing antibacterial particles (contains 0.75 wt % of antibacterial nanoparticles) was added and 33 wt % of methyl ethyl ketone (Daejung Chemicals & Metals Co., Ltd.) was added as a solvent in step 5 of Example 1.

### Example 3

An optical film was prepared in the same manner as in Example 1, except that 10 wt % of the dispersion containing antibacterial particles (contains 2.5 wt % of antibacterial nanoparticles) was added and 56 wt % of methyl ethyl ketone (Daejung Chemicals & Metals Co., Ltd.) was added as a solvent in step 5 of Example 1.

### Comparative Example 1

An optical film was prepared in the same manner as in Example 1, except that step 2 was not performed in Example 1.

### Comparative Example 2

An optical film was prepared in the same manner as in Example 1, except that steps 2 and 4 were not performed in Example 1.

### Comparative Example 3

Step 1: Antibacterial copper with a size of 100 μm was prepared.

Step 2: A hard coating composition was prepared by mixing 10 wt % of a monomer containing three methacrylates (M301, Miwon Commercial Co., Ltd.), 20 wt % of a monomer containing nine urethane acrylates (SC2100, Miwon Commercial Co., Ltd.), 1 wt % of 1-hydroxycyclohexylphenylketone (Igacure-184, Ciba) as a photoinitiator, 3 wt % of 2,4,6-trimethylbenzoyl-diphenyl-diphenylphosphine (TPO, Miwon Commercial Co., Ltd.), 33 wt % of methyl ethyl ketone (Daejung Chemicals & Metals Co., Ltd.) and 30 wt % of toluene (Daejung Chemicals & Metals Co., Ltd.) as a solvent, and adding 6 wt % of a dispersion containing the antibacterial copper (contains 25 wt % of antibacterial copper).

Step 6: The hard coating composition was applied to a PET substrate at a speed of 1 m/min using a bar coater and dried in a dry oven at 120° C. for 1 minute. An optical film with a 20 μm-thick hard coating was prepared by irradiating ultraviolet rays of 400 mJ/cm² to the dried substrate.

The contents of the photopolymeric resins, photoinitiators, TPOs, solvents, and dispersions used in Examples 1 to 3 and Comparative Examples 1 to 3 are shown in Table 1 below.

TABLE 1

| | photopolymeric | photo- | | | |
|---|---|---|---|---|---|
| | resin | initiator | TPO | solvent | dispersion |
| Example 1 | 30 wt % | 1 wt % | 3 wt % | 60 wt % | 6 wt % |
| Example 2 | 30 wt % | 1 wt % | 3 wt % | 63 wt % | 3 wt % |
| Example 3 | 30 wt % | 1 wt % | 3 wt % | 56 wt % | 10 wt % |
| Comparative | 30 wt % | 1 wt % | 3 wt % | 60 wt % | 6 wt % |
| Example 1 | | | | | |
| Comparative | 30 wt % | 1 wt % | 3 wt % | 60 wt % | 6 wt % |
| Example 2 | | | | | |
| Comparative | 30 wt % | 1 wt % | 3 wt % | 60 wt % | 6 wt % |
| Example 3 | | | | | |

### <Experimental Example 1> Surface Analysis

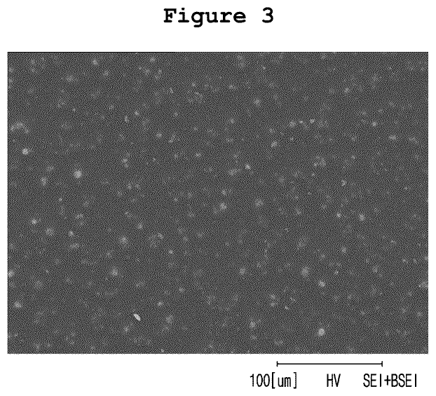

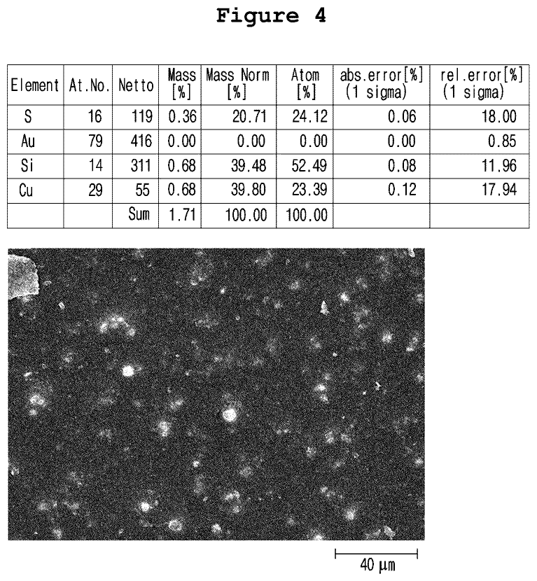

In order to analyze the surface shape and constituent elements of the optical film prepared according to the example, a surface analysis of the optical film prepared in Example 1 was performed using a scanning electron microscope (SEM) and energy dispersive X-ray spectroscopy (EDS). The results are shown in FIGS. 3 and 4.

FIG. 3 is a photograph of the surface of the film prepared according to Example 1 using a scanning electron microscope (SEM), and FIG. 4 shows the results of analyzing the surface of the film prepared according to Example 1 using energy dispersive X-ray spectroscopy (EDS). As shown in FIGS. 3 and 4, in the case of the optical film prepared in Example 1, it was confirmed that the micro-sized particles were uniformly distributed in the form of irregularities over the entire surface, and that the constituent elements of the particles were Si, Cu, and S.

Through this, it was found that the antibacterial particles composed of silica particles and surface-modified Cu—S-based nanoparticles were uniformly formed in the form of irregularities on the surface of the optical film.

### <Experimental Example 2> Evaluation of Wear Resistance

To evaluate the wear resistance characteristics of the optical films prepared according to Examples and Comparative Examples, an abrasion resistance test of the optical film of Example 1 and the optical film of Comparative Example 3 was performed by the following method.

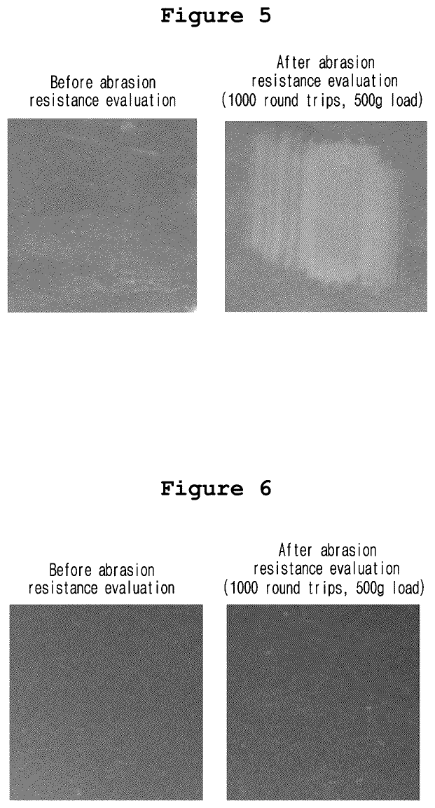

The abrasion resistance test was performed by placing an eraser on one side of each of the optical films of Example 1 and Comparative Example 3 and applying a load of 500 g and moving the eraser back and forth 30 times per minute. The condition of the film surface before and after 1000 round of the moving back and forth was observed under an optical microscope to evaluate the wear resistance characteristics, and the results are shown in FIGS. 5 and 6.

FIG. 5 shows the results for the optical film of Comparative Example 3, and FIG. 6 shows the results for the optical film of Example 1.

As shown in FIGS. 5 and 6, after 1000 round of the moving back and forth, it was found that the optical film of Comparative Example 1 was significantly worn, while the optical film of Example 1 was hardly worn.

From the above results, it was found that the optical film comprising the hard coating formed with the hard coating composition according to one aspect of the present invention had significantly excellent wear resistance.

### <Experimental Example 3> Evaluation of Optical Properties

In order to evaluate the light transmittance among the optical properties of the optical films prepared according to Examples and Comparative Examples, a transmittance measurement test was performed on the optical films prepared in Examples 1 and 3 and Comparative Examples 2 and 3 by the following method.

For the transmittance measurement test, the optical films prepared in Examples 1 and 3 and Comparative Examples 2 and 3 were cut into 5 cm×5 cm pieces and the transmittance in the visible light range of 400 nm to 800 nm was measured using an ultraviolet-visible spectrometer. The results are shown in Table 2 below.

TABLE 2

| | Transmittance (%) |
|---|---|
| Comparative Example 3 | 72.4 |
| Comparative Example 2 | 91.6 |
| Example 3 | 80.2 |
| Example 1 | 90.1 |

As shown in Table, it can be seen that the optical film of Example 1, which contained the photopolymeric resin and the antibacterial particles at a weight ratio of 30:1.5, and the optical film of Comparative Example 2, which simply mixed CuS with the hard coating composition, had significantly excellent transmittance of over 90%. It can also be seen that this value is significantly better than the transmittance (80.2%) of the optical film of Example 3 containing the photopolymeric resin and the antibacterial particles at a weight ratio of 30:2.5 and the transmittance (72.4%) of the optical film containing the antibacterial copper.

### <Experimental Example 4> Evaluation of Antibacterial Properties

In order to evaluate the antibacterial properties of the optical films prepared according to Examples and Comparative Examples, an antibacterial analysis test (ISO 22196) was performed on the optical films prepared according to Examples 1 to 3 and Comparative Example 1. The results are shown in Table 3 below.

TABLE 3

| | | Bacteria | Antibacterial |
|---|---|---|---|
| | | removed after | activity |
| Strain | Sample | 24 hours (%) | (Log[CFU/ml] 24 h) |
| E. coli | Example 1 (REF) | 99.9% | 7.1 |
| E. coli | Initial bacteria | 1.9 × 10⁵ | 7.1 |
| | number (CFU/film) | | |
| E. coli | Control (CFU/film) | 2.9 × 10⁸ | 7.1 |
| E. coli | Comparative | 91.6% | 1.1 |
| | Example 1 | | |
| E. coli | Initial bacteria | 2.3 × 10⁵ | 1.1 |
| | number (CFU/film) | | |
| E. coli | Control (CFU/film) | 7.8 × 10⁶ | 1.1 |
| E. coli | Comparative | 99.5% | 2.3 |
| | Example 2 | | |
| E. coli | Initial bacteria | 2.5 × 10⁵ | 2.3 |
| | number (CFU/film) | | |
| E. coli | Control (CFU/film) | 8.8 × 10⁶ | 2.3 |
| E. coli | Example 2 | 87.6% | 0.9 |
| E. coli | Initial bacteria | 2.3 × 10⁵ | 0.9 |
| | number (CFU/film) | | |
| E. coli | Control (CFU/film) | 1.0 × 10⁷ | 0.9 |

As shown in Table 3, in the case of the optical film of Example 1 containing the photopolymeric resin and the antibacterial particles at a weight ratio of 30:1.5, the bacteria removal rate after 24 hours was 99.9% and the antibacterial activity was 7.1 Log [CFU/ml], indicating that the antibacterial property of the film was significantly excellent.

It can also be seen that this value is significantly better than the bacteria removal rate (87.6%) of the optical film of Example 2, which contained the photopolymeric resin and he antibacterial particles at a weight ratio of 30:0.75.

From the results of Experimental Examples 3 and 4, it can be seen that when the hard coating composition according to one aspect of the present invention contained the photopolymeric resin and the antimicrobial particles at a weight ratio of 30:1 to 30:2, the hard coating formed with the same can exhibit significantly excellent light transmittance, antibacterial properties and wear resistance.

### INDUSTRIAL APPLICABILITY

The antibacterial particles according to one aspect of the present invention have the advantages of excellent light transmittance, antibacterial properties, and wear resistance. Accordingly, the hard coating composition comprising the antimicrobial particles, and the hard coating can be usefully applied to touch displays such as smartphones, tablets, and keyhosks, and to the surfaces of various household products.

What is claimed is:

1. Antibacterial particles comprising silica particles and Cu—S-based nanoparticles in which the Cu—S-based nanoparticles are bound to the surface of the silica particles.

2. The antibacterial particles according to claim 1, wherein the average diameter of the silica particles is 0.1 μm to 20 μm.

3. The antibacterial particles according to claim 1, wherein the average diameter of the Cu—S-based nanoparticles is 10 nm to 100 nm.

4. The antibacterial particles according to claim 1, wherein the Cu—S-based nanoparticles are copper sulfide nanoparticles having an atomic ratio of Cu:S of 1:0.5 to 1:15.

5. The antibacterial particles according to claim 1, wherein the Cu—S-based nanoparticles are surface modified to introduce organic functional groups on the surface.

6. A hard coating composition comprising a photo-curable resin and the antibacterial particles of claim 1.

7. The hard coating composition according to claim 6, wherein the photo-curable resin is an acrylate-based resin.

8. The hard coating composition according to claim 6, wherein the hard coating composition further includes a photoinitiator.

9. The hard coating composition according to claim 6, wherein the hard coating composition comprises the photo-curable resin and the antibacterial particles at a weight ratio of 30:1 to 30:2.

10. A hard coating comprising a photo-curable resin and the antibacterial particles of claim 1.

11. An antibacterial optical film comprising an optical substrate and the hard coating of claim 10.

12. The antibacterial optical film according to claim 11, wherein the hard coating has a thickness of 5 μm to 50 μm.

13. A method for producing antibacterial particles, comprising a step of binding the Cu—S-based nanoparticles to the surface of the silica particles.

14. The method for producing antibacterial particles according to claim 13, wherein the method further includes a step of surface modifying the Cu—S-based nanoparticles to introduce organic functional groups on the surface thereof.
